(19) United States
(12) Patent Application Publication
(10) Pub. No.: US 2009/0177832 A1
(43) Pub. Date: Jul. 9, 2009

(54) Parallel computer system and method for parallel processing of data

(75) Inventors: Anton Gunzinger, Zurich (CH); Tobias Gysi, Zurich (CH); Markus Herrli, Bern (CH); Leonardo Leone, Adliswil (CH); Stephan Moser, Winterthur (CH); David Mueller, Hinwil (CH)

Correspondence Address: RANKIN, HILL & CLARK LLP, 38210 Glenn Avenue, WILLOUGHBY, OH, 44094-7808, US

(73) Assignee: SUPERCOMPUTING SYSTEMS AG, Zurich (CH)

(21) Appl. No.: 12/268,027

(22) Filed: Nov. 10, 2008

(30) Foreign Application Priority Data
Nov. 12, 2007 (CH) 1743/07

(51) Int. Cl. G06F 13/00

(52) U.S. Cl. 710/316

(57) ABSTRACT

The invention relates to multi-computer systems, wherein each computer (100, 200, . . . , N00) comprises a central processor (101, 201, . . . , N01) and working memory (103, 203, . . . , N03). According to one aspect of the invention, the “Internal High Speed Interconnect” (104, 204, . . . , N04) is extended beyond the internal limits of the computer and impinges upon the “High Speed Switch” (1). If need be, a single data conversion is performed in the High Speed Switch (100, 200, . . . , N00), specifically at the High Speed Interconnect Interface, and from that point the data is transferred through the “Switching Matrix” in a manner analogous to the state of the art.

### BACKGROUND OF THE INVENTION

1. Field of the Invention

The present invention is concerned with a method for parallel processing of data, and with the operation of a parallel computer system as well as multiple parallel computer systems.

2. Description of Related Art

Demanding computer applications, such as the simulation of technical systems, Internet servers, audio- and video servers (“Video on Demand”), and data centers require ever more processing power. At present, this processing power can be inexpensively supplied by computer systems that are connected in parallel.

In parallel computer systems, the total system performance is strongly dependent on the communication system it employs. The critical aspects of such a system are bandwidth (the amount of data that can be transported in a given time) and latency (the time lag between when a communication function is called in the sending processor and reception in the application on the receiving processor). It is therefore understood that a high-tech solution that results in high bandwidth and low latency is highly desirable.

A parallel computer system according to the state of the art, as shown in FIG. 1, consists of several computers (100, 200, . . . N00), which are connected together via a “High Speed Switch” (1). An individual computer (100, 200, . . . N00) comprises a “Central Processing Unit” (101, 201, . . . N01), “Memory” (103, 203, . . . N03) as well as a connecting module (“North Bridge”) (102, 202, . . . N02). Other parts of a computer, for example the input/display hardware, hard disk, CD drive, power supply, etc. are omitted from this schematic for clarity, since they are not relevant for the present description of the parallel method.

In order for a computer system (e.g. 100) to communicate with another computer system (e.g. 200), the CPU of the sending computer calls up a system function. Next, the data is transferred over the “Internal High Speed Interconnect” (104, 204, . . . N04) to the NIC (Network Interface Card). In many cases the NIC is substituted by a chip on the computer's motherboard, which can perform the same logical functions as the NIC. The “Internal High Speed Interconnect” often takes the form of PCI (Peripheral Computer Interconnect), a parallel bus system, or, more recently, PCIe (PCI express), a serial high-speed communications system. PCI typically provides bandwidth of 133 MB/s, 266 MB/s, 532 MB/s and 1064 MB/s; PCIe provides anywhere from 2.5 Gbit/s (˜250 MB/s) to 80 Gbit/s (˜8000 MB/s). The NIC converts the data from “Internal High Speed Interconnect” to a serial format compatible with the “External High Speed Interconnect” (107, 207, . . . N07). There are many standards for “External High Speed Interconnect” protocols, including: Gigabit Ethernet, Infiniband, Myrinet, and others.

The “External Interface” portion of the sender's NIC (106, 206, . . . N06) does not only serialize the data, it also assembles it into packets, and attaches sender- and receiver addresses as well as a checksum. In the “External Interface” (108, 208, . . . N08), the packet data is once again unpacked, and the checksum removed. Frequently, the data is once again parallelized in order to run through the “Switching Matrix”. The “Switching Matrix” function can be performed by any one of many familiar technologies (serial, parallel or a combination of both), and topologies (1-D, 2-D, 3-D networks; 1-D, 2-D, 3-D Torus, “Fat Tree”, Multi-Stage, etc.). The path through the “Switching Matrix” is determined by the sender according to the receiver addresses of the individual data packets. In the “External Interconnect” (in this example, 208), the data packets are converted into “External Interconnect Protocol” (207), transferred to the receiver computer (200), and received via its “External Interface” (206), as previously described. The checksums, sender- and receiver addresses are removed, the storage address processed in the “Memory” (203), and the data transferred to the memory. Finally, the application, which is running in the processor (201) signals that new data have been received. Specific mechanisms for error detection, determination of access permissions, etc., are not discussed here, since they are not important for understanding the present invention.

### BRIEF SUMMARY OF THE INVENTION

This description of a state-of-the-art data transfer process should make clear that the route from sender to receiver involves many protocol conversions. These conversions are not only complex (and therefore “expensive”), but they also introduce a discernible transmission lag (latency), and can result in decreased bandwidth. In addition, the necessity of assembling data and commands into network packets makes their interpretation by the switch more difficult, and therefore limits the further functionality of the switch itself.

It is the purpose of the present invention to provide a method and a parallel computer system which overcomes the disadvantages of the state-of-the-art, and in particular makes possible communication between a plurality of computers, while reducing the latency (lag time) and expenditure on hardware necessary for said communication.

According to an aspect of the invention, a parallel computer system is provided, the computer system comprising a plurality of computers and a switch, wherein each computer comprises a central processor and a working memory, wherein the components of each computer communicate via an Internal High Speed Interconnect, and wherein the Internal High Speed Interconnect is connected directly to the switch, without intermediary protocol conversion.

According to another aspect of the invention, a method for communication in a parallel computer system with a plurality of computers and a switch is provided, the method comprising the steps of providing a first and a second computer of the parallel computer system, the first and second computers comp supporting a computer internal signal transmission format, of sending, by the first computer, data in the computer internal signal transmission format to the switch, of sending, by the switch, the data in the computer internal signal transmission format to the second computer, and of receiving the data, by the second computer, in the computer internal signal transmission format.

According to yet another aspect of the invention, a parallel computer system is provided, the system, comprising a plurality of computers and a switch, wherein each computer comprises a central processor and a working memory, wherein components of each computer communicate via an Internal High Speed Interconnect, and wherein the Internal High Speed Interconnect is connected directly to the switch, without intermediary protocol conversion, and wherein the switch is capable of at least one of performing data operations on data supplied by at least one of the computers, of storing and/or managing transactional memory, of storing data of applications, of executing commands from applications, of containing operating system information of at least one of the computers, and of executing locking mechanisms and/or barrier mechanisms.

### BRIEF DESCRIPTION OF THE DRAWINGS

FIG. 1 shows a parallel computer system according to the state of the art, and

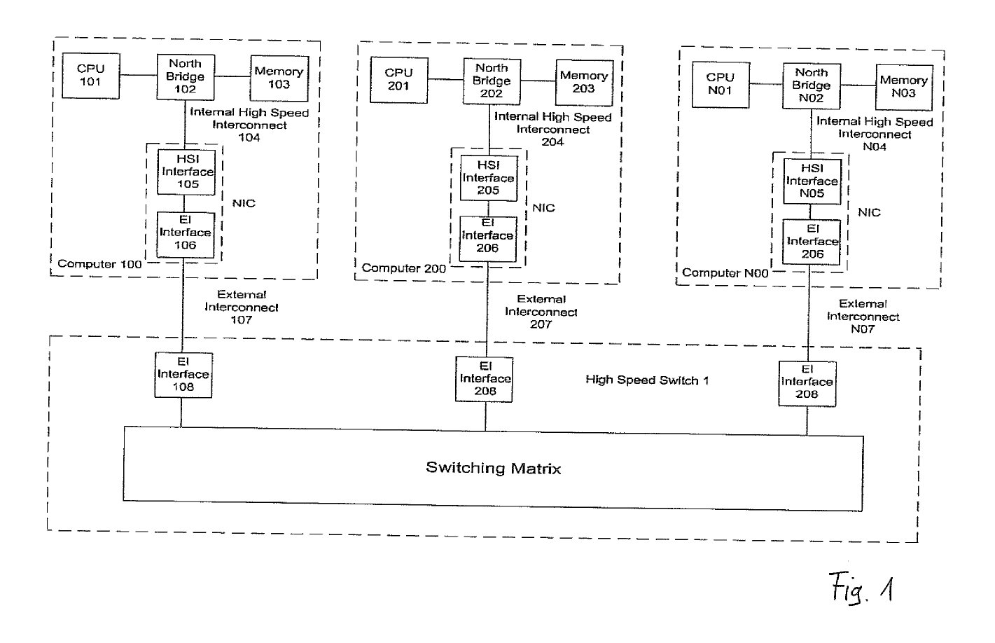

FIG. 2 shows a parallel computer system according to an embodiment of the invention.

### DETAILED DESCRIPTION OF THE INVENTION

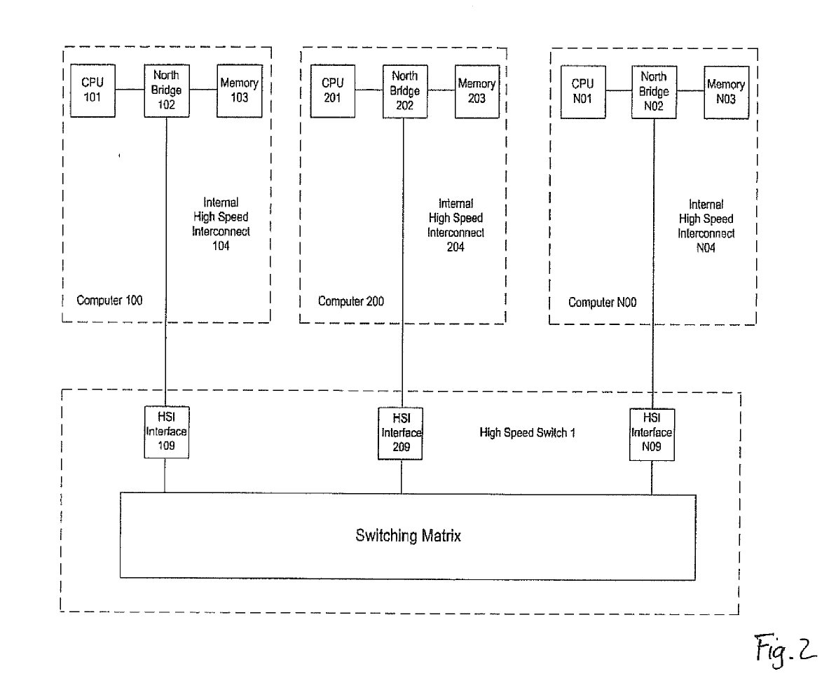

According to one aspect of the invention, the “Internal High Speed Interconnect” (104, 204, . . . N04) is extended past the internal limits of the computer, as far as the High Speed Switch (1), as shown schematically in FIG. 2. In this example, a single data conversion is performed in the High Speed Switch (100, 200, . . . N00), specifically at the High Speed Interconnect Interface (109, 209, . . . N09), and from that point the data is transferred through the “Switching Matrix” in a manner analogous to the state of the art.

The invention, among other things, takes advantage of a surprising phenomenon: it is possible to transmit the “Internal High Speed Interconnect” signal over distances of up to 15 meters and more.

In a preferred embodiment of this invention, serial protocols (for instance, PCIexpress) are used as “Internal High Speed Interconnect”. In this case, as a rule, differential signals of very high bandwidth (e.g. 2.5 Gbit/s per differential signal pair) are used.

With the present invention, the protocol conversions involved in a particular data transfer from sender to receiver are significantly reduced. Therefore, there is a corresponding reduction in the complexity of the process, its cost, and its power consumption. As a consequence, in comparison to the state of the art, a lower latency is achieved. Altogether, it can be expected that latency can be reduced by 30-40% over the state of the art, and the overall speed of the system roughly doubled. The specific amount of improvement depends upon both the specific implementation of the system and the applications being run, and can be less than these estimates, but can also be considerably more, particularly if the recommended application(s) and other recommended measures are followed, as described below.

The preferred embodiment of the invention allows not only decreased latency in transmission of signals, but also allows more efficient connections for distributed operations (for instance, “Barrier Synchronization”, “Locks”, or collective operations). The state of the art solution involves steps in the Network Interface Card (NIC) (e.g. protocol conversions and packeting) which, for example, result in lost data. In the preferred embodiment of this invention (direct use of the Internal High Speed Interconnect Signal) distributed operations can be seamlessly integrated into the switch itself and therefore the performance of these operations can be significantly increased. In addition, simple operations like additions, the calculation of maxima/minima, z-buffers or others can be performed in the switch itself. This eliminates the need for “costly” conversion processes, and eliminates the need for signals to pass through the bottleneck of an “External High Speed Interconnect” and be delegated to a computer. That brings enormous performance advantages for certain applications like the data base management.

The present invention is also advantageous for systems with distributed memory processing, for which also a lower latency and higher bandwidth can be achieved. Particular advantages result when, for example, the switch takes over the aforementioned “Locking” process, or in another example when transactional memory is saved and/or executed in the switch (in the Switching Matrix). The Transactional Memory may also be distributed among a plurality of physical components by the Switching Matrix.

Depending on the specific embodiment, application and/or version of the invention, one or more of the following characteristics and features of a computer system can be considered as aspects of the invention: the considerations refer in each case to a parallel computer system with a plurality of computers and (at least) one switch, wherein each computer possesses a central processor and random access memory:

Neither a Network Interface Card (NIC) nor a chip or chip component performing the Network Interface Card's function is necessary for communication between the computer and the switch. Instead, the computer's capability for extremely fast, internal communication between its components is utilized; the switch, or as the case may be an interface of the switch, is effectively treated as an internal component of the computer.
The transfer of data from the computer to the switch requires no special protocol in order for the data transfer to be compatible with the computer network; therefore no protocol conversion is necessary for the transfer to occur.
The switch communicates with the individual computers via the PCIe protocol or, in the case of communications with internal peripherals, serial protocol. Preferably, the switch is in direct communication contact (i.e. communication without intermediate processing and/or protocol conversion) with a component of the computer (for example, North Bridge, South Bridge, or the CPU itself), and the data (here this term encompasses call and commands and other signals as well) from the CPU is in a format compatible with the computer's internal auxiliary equipment.
In contrast to the state of the art, in the present invention, there is at most one protocol conversion necessary between the CPU and the functional entrance of the switch—namely the one between the CPU's internal protocol (this is usually proprietary and depends on the type of computer—and for example is used on the front-side bus) and the protocol for the Internal High Speed Interconnect format (currently for example PCIe). Therefore, a command from one computer's CPU to another CPU in another computer (or an access to another computer's corresponding working memory) necessitates at most four protocol conversions, namely: CPU—Internal High Speed Interconnect protocol, Internal High Speed Interconnect protocol—switch, switch—Internal High Speed Interconnect protocol, and Internal High Speed Interconnect protocol—CPU.

The method according to the invention (or according to aspects of the invention) combines the advantages of multi-computer systems built according to state of the art procedures, and specialized data-processing parallel computing systems that incorporate special components (including special CPUs): the method according to the invention can be applied to mass-market computers with standard CPUs and standard motherboard architecture—which are mass-market products and thus cost-effective. The method according to the invention allows such systems built with standard components to at least approach the speed and efficiency of expensive, specialized parallel data-processing systems (in which the processors are usually interconnected with parallel data links as well).

A computer system built according to the invention can take various physical forms. In a first example, each of a plurality of individual computers is a standard off-the-shelf personal computer, complete with case, and the computer system is created by arranging the various individual computers in a particular area (for example, a room), along with the switch.

In a second example of the invention, a plurality of uncased computer components are arranged in one or more racks, where at least one of the racks holds the switch as well. In this embodiment, each “computer” is an individual main circuit board (that is, the motherboard).

Of course, other physical arrangements of a plurality of computers (with or without cases or additional components) are possible.

The first and second embodiments of the invention are particularly appropriate for relatively small clusters of computers; the second example in particular is appropriate for 16 or 32 computers, or another two- or even one-digit number. Both examples can incorporate a simple star architecture—that is, an Internal High Speed Interconnect data link connects each computer to the switch.

The invention can also, without further modification, be applied to complicated, hierarchical system topologies, in which groups of computers are connected to their respective blocks of switches, and these blocks of switches are themselves in communication with each other (of course, the topology of the connections between the several blocks can optionally be hierarchical as well, etc.—all network topologies that are possible for current state of the art solutions are also possible in embodiments of the invention). If another format than the Internal High Speed Interconnect format is used for communication between the blocks of switches, the blocks and their associated clusters of computers can be located at a greater physical distance from one another—perhaps even in different buildings. If hierarchical topologies are employed, the present invention can be scaled up to systems that include a hundred or more or even a thousand or more computers.

Of course, in all of the examples given here, various additional hardware such as peripherals, hard discs or other data storage means, DVD drives, and/or input/output hardware, etc., may be present or not present.

In each example each computer can have exactly one central processor, or one or more of the computers can have multiple central processors. As mentioned above, the processors can be of the mass-market type (note: with respect to working memories, each computer can also have either one or more than one).

In each example, the switching function can be performed by any switch technology known to the state of the art (for example, a matrix switch with a switching matrix, or some other kind of known switch). The switch (for example the switching matrix) can be implemented in any known topology, for instance 1-D-, 2-D-, 3-D-networks, “Flat Tree”, Torus, Multi Stage, K-Ring, Single Chip Switching, etc. As mentioned above, the switching function can also be performed by several interconnected blocks of switches.

As shown in FIG. 2, the switch can comprise High Speed Interconnect Interfaces that are, on one side, compatible with the Internal High Speed Interconnect (104, 204, . . . N04) protocol. Preferably, these interfaces are a physical part of the switches themselves (in such a case a standard switch can be used, and configured according to the interface setup); however in principle they can also be arranged elsewhere.

In addition to its primary switching function, the switch can also be tasked with additional functionality, for example in “distributed memory” approaches, control of virtual memory, etc.

The High Speed Interconnect Interfaces can also be configured such that they can convert a local access mechanism for the local computer into global access mechanisms for the switch (or, as the case may be, switching matrix), so that call and/or access commands to the memory of other computers in the system are possible, irrespective of the specific memory management of the individual computer(s).

The switch can hold information about the operating system of the individual computers—for example “page tables” and/or others—and therefore make possible an operating system bypass, so that individual applications can have immediate access to data from other computers. Such a feature would be very difficult to achieve with a multi-computer system constructed according to the state of the art, because all the data would have to be converted into the External High Speed Interconnect, and to be transmitted via the latter.

Further possibilities associated with the invention are possible, and arise from the fact that the switch stores data and/or can receive and perform operations for applications. For example, the switch can grant individual computers' applications access to stored data, subject to predetermined rules (permissions for writing, reading, etc.)—such access control happens very quickly and efficiently. In addition, certain operations, as for example the “max” operation or of a sum, can sometimes be completed more quickly in the switch than if another computer was required to perform them. The combination of these two functionalities, “data stored in switch” and “operations performed in switch” is very advantageous. When combined with “distributed memory” approaches these become particularly interesting for locking mechanisms and barrier-mechanisms, which can be carried out in the switch as well.

Some approaches to parallel processing of data provide for “transactional memory”. If the present invention is applied to one of these methods, the “transactional memory” can be managed and/or stored in the switch. Such a feature brings improvements to efficiency, and can be achieved in state of the art multi-computer systems only with great difficulty. The switch can, for example, allocate or partition the transactional memory among a plurality of physical components.

In summary, the invention pertains to multi-computer systems with a plurality of computers, wherein each computer comprises a CPU, working memory, and, for example a “North Bridge” and an Internal High Speed Interconnect, and wherein the Internal High Speed Interconnect reaches out directly to the High Speed Switch. Depending on the architecture of the particular computers used, the Internal High Speed Interconnect can be connected to the CPU either directly, or via a North Bridge and South Bridge.

Thus, the Internal High Speed Interconnect serves as a direct external connection to the High Speed Switch.

For each Internal High Speed Interconnect, the High Speed Switch can provide a High Speed Interconnect Interface. In such a case, it is compatible on one side with the protocol of the Internal High Speed Interconnect, and on the other with the protocol of the switching matrix.

For the switching matrix of high speed switches, all appropriate known technologies can be used. For example, the switching matrix can be realized in known topologies (1-D, 2-D, 3-D networks; “Fat Tree”, Torus, Multi-Stage, K-Ring, Single Chip Switching, etc.).

According to a special embodiment suitable for large systems, the switching matrix with multiple blocks can be realized. The individual blocks can be connected to one another via either the same technology that is used in the Internal High Speed Interconnect, or via another technology.

The High Speed Interconnect Interfaces can also be configured so that they can convert a local access mechanism for the local computer into global access mechanisms for the switching matrix.

The switching matrix can store information, for example, information for the operating system of individual computers, and serve as an OS-bypass to provide this data directly to the individual computers' applications.

According to another embodiment of the invention, the switching matrix can store data, and provide this data to applications running on the computers, according to predetermined access rules (writing, reading, etc.).

The switching matrix can, for example, receive instructions from applications, and execute said operations.

For instance, locking mechanisms or barrier mechanisms can be executed in the switching matrix.

It can also be imagined that the switching matrix can store and/or manage transactional memory. The switching matrix can also distribute the transactional memory amongst a plurality of physical components.

1. A parallel computer system, comprising a plurality of computers and a switch, wherein each computer comprises a central processor and a working memory, wherein components of each computer communicate via an Internal High Speed Interconnect, and wherein the Internal High Speed Interconnect is connected directly to the switch, without intermediary protocol conversion.

2. The computer system of claim 1, wherein at least some of the computers also comprise a North Bridge chip for throughput of data between the central processor and the random access memory and/or a South Bridge chip for throughput of data to peripheral devices, and wherein the Internal High Speed Interconnect communication link is between on the one side the North Bridge chip or the South Bridge chip and, on the other side, the switch.

3. The computer system of claim 1, wherein the Internal High Speed Interconnect communication link is between the central processor and the switch.

4. The computer system according to claim 1, wherein a serial communication system is employed as the Internal High Speed Interconnect.

5. The computer system of claim 4, wherein the Peripheral Computer Interconnect express (PCIe) communication system is employed as the Internal High Speed Interconnect.

6. The computer system according claim 1, wherein the switch possesses a High Speed Interconnect Interface for each Internal High Speed Interconnect, in which High Speed Interconnect Interface a protocol conversion into a data protocol compatible with the switch is possible.

7. The computer system of claim 6, wherein the High Speed Interconnect Interface has the capability of converting a local access mechanism for a local computer into a global access mechanism.

8. The computer system according to claim 1, wherein the switch comprises several blocks, of which each is connected to a plurality of computers, and wherein the blocks have communication links between them.

9. The computer system of claim 8, wherein communication between the blocks of switches occurs via the same communication system as for the Internal High Speed Interconnect.

10. The computer system according to claim 1, wherein the switch contains operating system information from the individual computers, and therefore can access data of the applications of the computers directly.

11. The computer system according to claim 1, wherein the switch stores data which applications on the computers can access, subject to predetermined rules.

12. The computer system according to claim 1, wherein the switch can receive and execute commands from applications on the computers.

13. The computer system according to claim 1, wherein the switching matrix can execute locking mechanisms and/or barrier mechanisms.

14. The computer system according to claim 1, wherein the switch stores and/or manages transactional memory.

15. The computer system of claim 14, wherein the transactional memory is distributed among a plurality of physical components by the switching matrix.

16. The computer system according to claim 1, wherein data operations are possible within the switch, for example, the calculation of maxima, minima, z-buffers, or others.

17. A method for communication in a parallel computer system with a plurality of computers and a switch, the method comprising the steps of providing a first and a second computer of the parallel computer system, the first and second computers comp supporting a computer internal signal transmission format, of sending, by the first computer, data in the computer internal signal transmission format to the switch, of sending, by the switch, the data in the computer internal signal transmission format to the second computer, and of receiving the data, by the second computer, in the computer internal signal transmission format.

18. The method according to claim 17, comprising the additional steps of converting the data received from the first computer upon entering the switch from the computer internal signal transmission format to another format, and of converting the data upon exiting the switch from this other format back into the computer internal signal transmission format.

19. A parallel computer system, comprising a plurality of computers and a switch, wherein each computer comprises a central processor and a working memory, wherein components of each computer communicate via an Internal High Speed Interconnect, and wherein the Internal High Speed Interconnect is connected directly to the switch, without intermediary protocol conversion, and wherein the switch is capable of at least one of performing data operations on data supplied by at least one of the computers, of storing and/or managing transactional memory, of storing data of applications, of executing commands from applications, of containing operating system information of at least one of the computers, and of executing locking mechanisms and/or barrier mechanisms.

20. The parallel computer system according to claim 19, wherein the Internal High Speed Interconnect is the Peripheral Computer Interconnect express (PCIe) communication system.
